(19) United States
(12) Patent Application Publication
(10) Pub. No.: US 2002/0030994 A1
(43) Pub. Date: Mar. 14, 2002

(54) Fuel cell powered portable light

(76) Inventors: Mark Krietzman, Palos Verdes Estates, CA (US); Fred Arbenz, Newport Beach, CA (US)

Correspondence Address: LEONARD TACHNER, A PROFESSIONAL LAW CORPORATION, SUITE 38-E, 17961 SKY PARK CICLE, IRVINE, CA, 92614, US

(21) Appl. No.: 09/826,042

(22) Filed: Apr. 3, 2001

Related U.S. Application Data
(60) Provisional application No. 60/194,638, filed on Apr. 4, 2000.

(51) Int. Cl. F21L 4/04; F21L 13/00

(52) U.S. Cl. 362/259; 362/192; 362/183; 362/205

(57) ABSTRACT

A combination of an electrically powered portable light and a reuseable portable fuel cell provides a practical light source which may be operated by a plurality of alternative sources of electrical energy such as a battery, a generator, a solar cell, and an A/C current converter.

### BACKGROUND OF THE INVENTION

1. Field Of The Invention:

This present invention relates to a novel method combination of lighting and a unified regenerative fuel cell. The addition of self-recharging mechanism and output limiting circuitry provide a novel light.

2. Background:

A fuel cell powered light or lantern, using reversible PEM membrane fuel cells can be charged by a solar panel, a windmill, handcrank and generator or off a homes A/C current. No hydrogen, methane, or butane to add.

A 1.5 to 9 volt fuel cell operates a pressures and temperatures safe for consumer use.

### SUMMARY OF INVENTION

Accordingly, it is an object of the invention to provide a novel fuel cell powered portable light.

It is yet another object of the invention to provide a novel wind-up fuel cell powered portable light.

It is yet another object of the invention to provide a novel solar-cell charged fuel cell powered portable light.

It is yet another object of the invention to provide a novel wind charged fuel cell powered portable light.

It is yet another object of the invention to provide a novel foot charged fuel cell powered portable light.

It is yet another object of the invention to provide a novel A/C current charged fuel cell powered portable light.

The features of the invention believed to be novel are set forth with particularity in the appended claims. The invention itself, however, both as to configuration, and method of operation, and the advantages thereof, may be best understood by reference to the following descriptions taken in conjunction with the accompanying drawings.

### BRIEF DESCRIPTION OF THE DRAWINGS

FIG. 1 illustrates a component view of the portable fuel cell light.

FIG. 2 illustrates a schematic view of the portable fuel cell light.

FIG. 3 illustrates an alternate schematic of the portable fuel cell light.

FIG. 4A illustrates a component view of a first alternate embodiment of the portable fuel cell light.

FIG. 4B illustrates a perspective view of the embodiment of FIG. 4A.

FIG. 4C illustrates a partial side view of the embodiment of FIG. 4A.

FIG. 4D illustrates a back view partial of the embodiment of FIG. 4A.

FIG. 5 illustrates a component view of a second alternate embodiment of the portable fuel cell light.

### MODES FOR CARRYING OUT THE INVENTION

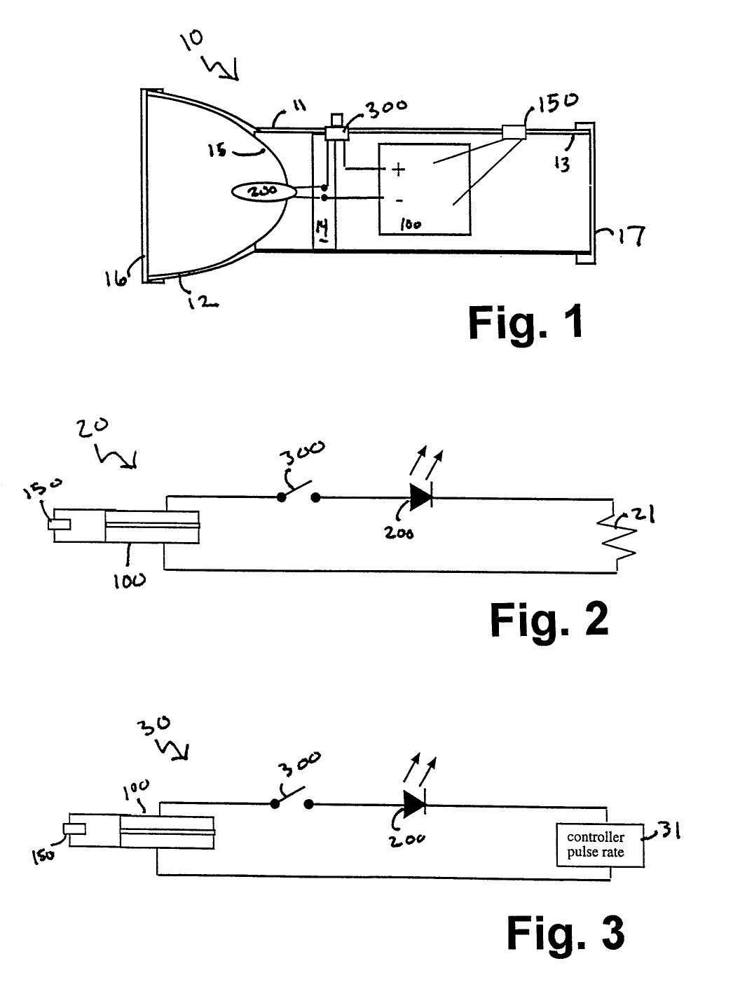

Referring now to the drawings, there illustrated in FIG. 1 there is illustrated a component view of the portable fuel cell light generally designated 10.

Within a tubular casing 11, with an open front 12 and rear 13 is a bisecting plate 14 into which mounts a light-emitting-diode 200, which is connected to a fuel cell 100, via a momentary switch 300.

A parabolic dish 15 may be placed around the light-emitting-diode 200 to collimate the output. A clear lens cover 16 is placed over the open front 12 and a removable end cap 17 is placed over the open rear.

To recharge the fuel cell 100, it may be removed from the casing 11 and charged; or a recharge “on/off” switch & plug 150 may be added to allow charging via battery, Windmill driven generator, a solar cell, an A/C current with converter, while encased.

Referring now to FIGS. 2 and 3 there are shown two schematic of the portable fuel cell light, generally designated 20 & 30.

The fuel cell's 100 discharge rate may be controlled and the electricity available for illumination conserved by appropriate resistors 21 added to the circuit to limit current flow to the light-emitting-diode 200. Alternatively the light-emitting-diode 200 use of current may be reduced by adding a pulse-rate controller 31 to strobe the light-emitting-diode 200 at a rate above the threshold of visual acuity.

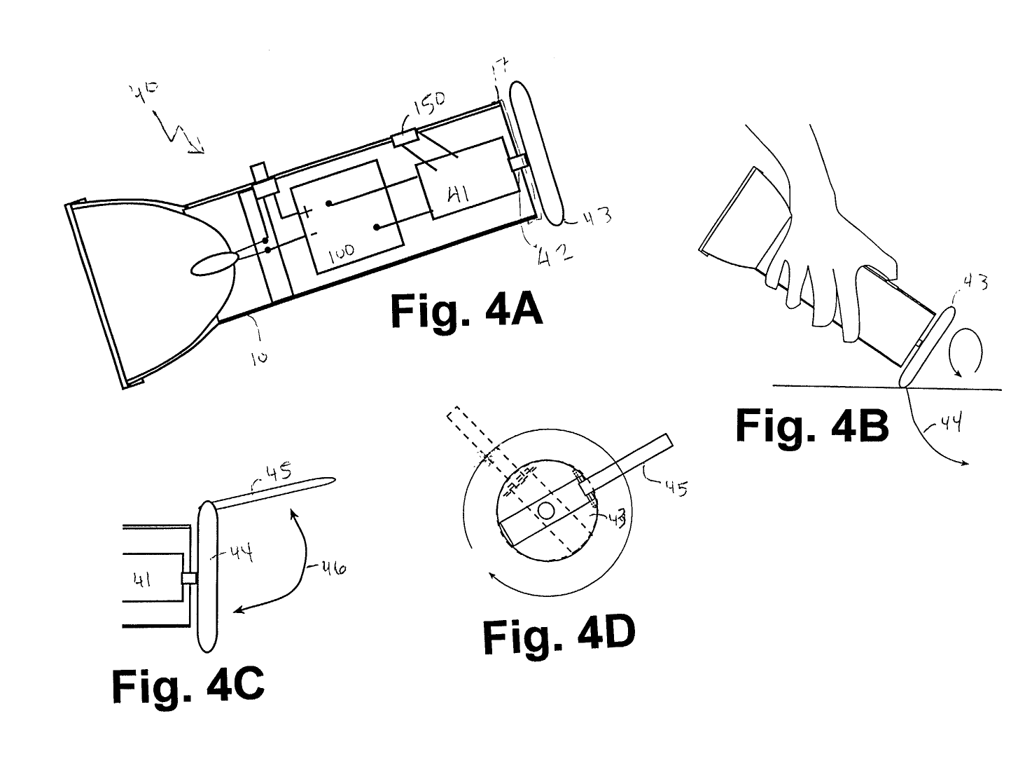

Referring now to FIGS. 4A-4D there is illustrated a first alternate embodiment of the portable fuel cell light, generally designated 40.

Added to the portable fuel cell light of FIG. 1 generally designated 10, is a small generator magnet/coil 41 type conductively connected to the fuel cell 100, via the recharge “on/off” switch & plug 150, and with a shaft 42, extending through the removable end cap—17 and affixed to a rubberized flywheel 43. Shown in FIG. 4B is the spinning of the flywheel 43 by drawing it in an arc along the line of arrow 44 across the ground. Shown in FIG. 4C and 4D is the hand crank 45 nested within the flywheel 44 which folds out and may be hand turned along the line of arrow 46 to turn the flywheel 43. The turning of the flywheel spins the small generator magnet/coil 41 and charges the fuel cell 100.

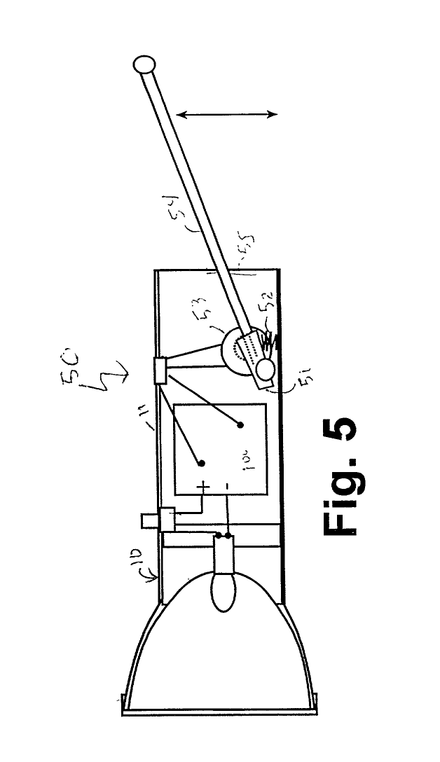

Referring now to FIG. 5 there is illustrated a second alternate embodiment of the portable fuel cell light, generally designated 50.

Added to the portable fuel cell light of FIG. 1 generally designated 10, inside the casing 11 is a foot lever receiving mount 51 resting on a return spring 52 which connects to a small generator magnet/coil type 53 a foot lever 54 is inserted into the foot lever receiving mount 51 via a lever guide in the casing 55 whereby the up and down movement of the foot lever 54 causes the small generator magnet/coil type 53 to spin and charge the fuel cell 100. A foot lever is beneficial in that the human foot of a child can produce forces many times greater than the hand winding by a human adult.

Since certain changes may be made in the above apparatus without departing from the scope of the invention herein involved, it is intended that all matter contained in the above description, as shown in the accompanying drawing, shall be interpreted in an illustrative, and not a limiting sense.

What is claimed is:

1. A portable fuel cell powered light comprising:
(a) a casing;
(b) a fuel cell;
(c) a light emitting means conductively linked to said fuel cell; and,
(d) a switching means.

2. The portable fuel cell powered light according to claim 1, wherein said switching means is a momentary switch.

3. The portable fuel cell powered light according to claim 1, wherein said switching means is on/off switch.

4. The portable fuel cell powered light according to claim 1, wherein said switching means is variable resistance switch.

5. The portable fuel cell powered light according to claim 1, wherein said light emitting means is a light-emitting diode.

6. The portable fuel cell powered light according to claim 1, wherein said light emitting means is a light bulb.

7. The portable fuel cell powered light according to claim 5, further comprising a parabolic reflecting dish placed around said light emitting means to collimate the output from said light emitting means.

8. The portable fuel cell powered light according to claim 1, further comprising a recharge on/off switch with plug-in affixed through said casing and conductively linked to said fuel cell.

9. A portable fuel cell powered light comprising:
(a) a casing;
(b) a fuel cell;
(c) a light emitting means conductively linked to said fuel cell;
(d) a recharging means;
(e) a first witching means, whereby said light emitting means is switched on; and
(f) a second switching means whereby said fuel cell may be conductively linked to said recharging means.

10. The portable fuel cell powered light according to claim 9, wherein said light emitting means is a light-emitting diode.

11. The portable fuel cell powered light according to claim 9, wherein said light emitting means is a light bulb.

12. The portable fuel cell powered light according to claim 9, further comprising a parabolic reflecting dish placed around said light emitting means to collimate the output from said light emitting means.

12. The portable fuel cell powered light according to claim 9, wherein said recharging means is a magnet/coil generator attached to a flywheel.

13. The portable fuel cell powered light according to claim 9, wherein said recharging means is a magnet/coil generator attached to a foot lever.

14. The portable fuel cell powered light according to claim 9, wherein said recharging means is a solar panel.

15. The portable fuel cell powered light according to claim 9, wherein said recharging means is an external battery.

16. The portable fuel cell powered light according to claim 9, wherein said recharging means is a windmill driven generator battery.

17. A portable fuel cell powered light comprising:
(a) a casing;
(b) a fuel cell;
(c) a light emitting means conductively linked to said fuel cell;
(d) a switching means; and,
(e) a current limiting means, whereby said light emitting means current draw from said fuel cell is controlled.

18. A portable fuel cell powered light comprising:
(a) a casing;
(b) a fuel cell;
(c) a light emitting means conductively linked to said fuel cell;
(d) a switching means; and,
(e) a pulsing controller whereby said light emitting means pulse rate is controlled thereby reducing current draw from said fuel cell.
